(19) United States
(12) Patent Application Publication
(10) Pub. No.: US 2019/0204784 A1
(43) Pub. Date: Jul. 4, 2019

(54) APPARATUS FOR DISPLAYING HOLOGRAM

(71) Applicant: ELECTRONICS AND TELECOMMUNICATIONS RESEARCH INSTITUTE, Daejeon (KR)

(72) Inventors: Keehoon HONG, Daejeon (KR); Kwan-Jung OH, Daejeon (KR); Hyon-Gon CHOO, Daejeon (KR); Yongjun LIM, Sejong (KR)

(21) Appl. No.: 16/224,542

(22) Filed: Dec. 18, 2018

(30) Foreign Application Priority Data
Dec. 28, 2017 (KR) 10-2017-0182936
Dec. 17, 2018 (KR) 10-2018-0163559

(51) Int. Cl. G03H 1/26

(52) U.S. Cl. CPC G03H 1/2645; G03H 2225/12; G03H 2223/50; G03H 2223/15

(57) ABSTRACT

In the present invention, by providing an apparatus for displaying a hologram including: a beam source configured to output a plurality of beams, a spatial light modulator configured to include a plurality of SLM (spatial light modulator) regions, display a hologram, and diffract the plurality of beams; a plurality of front lenses each corresponding to the plurality of SLM regions, and configured to refract the plurality of beams diffracted from each of the plurality of SLM regions; a plurality of filters each corresponding to the plurality of SLM regions, and configured to filter a part of the plurality of refracted beams; and a plurality of back lenses each corresponding to the plurality of SLM regions, and configured to display an interference image corresponding to the hologram using the filtered part beam, the beam path of the hologram displaying apparatus can be drastically reduced, and an entire size of the hologram displaying apparatus can be reduced, so that it is possible to down-size the digital hologram display system.

### CROSS-REFERENCE TO RELATED APPLICATION

This application claims priority to and the benefit of Korean Patent Application No. 10-2018-0163559 filed in the Korean Intellectual Property Office on Dec. 17, 2018, and Korean Patent Application No. 10-2017-0182936 filed in the Korean Intellectual Property Office on Dec. 28, 2017, the entire contents of which are incorporated herein by reference.

### BACKGROUND OF THE INVENTION

### (a) Field of the Invention

The present invention relates to a digital hologram displaying apparatus including a spatial filter.

### (b) Description of the Related Art

Recently, the development of a three-dimensional display technique has utilized three-dimensional images in various industries. Particularly, techniques using holograms which display objects in real life are being actively studied, and contents using holograms in various fields such as broadcasting, exhibition, and performance are being produced.

The holography technique is a technique for displaying the hologram on a spatial basis using the phenomenon of beam interference. Among the holography, digital holography is a technique to simultaneously record the amplitude information and the phase information of a beam using a laser, which is a coherent beam source.

Based on these technical features, digital holography includes varies fields such as holographic display for displaying three-dimensional images, holographic printing, large capacity hologram storage techniques for storing holograms, holography measurement techniques such as holographic microscopy for three-dimensional measurement, and so on.

This work was supported by a ‘The Cross-Ministry Giga KOREA Project’ grant funded by the Korean government (MSIT) (GK17C0200, Development of full-3D mobile display terminal and its contents).

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides an apparatus for displaying a hologram for reducing an optical path compared to a conventional technique.

An apparatus for displaying a hologram according to an exemplary embodiment of the present invention includes: a beam source configured to output a plurality of beams; a spatial light modulator configured to include a plurality of SLM (spatial light modulator) regions, display a hologram, and diffract the plurality of beams; a plurality of front lenses each corresponding to the plurality of SLM regions, configured to refract the plurality of beams diffracted from each of the plurality of SLM regions; a plurality of filters each corresponding to the plurality of SLM regions, and configured to filter a part of the plurality of refracted beams; and a plurality of back lenses each corresponding to the plurality of SLM regions, and configured to display an interference image corresponding to the hologram using the filtered part beam.

Diameter-focal length ratios of each of the plurality of front lenses are the same.

Diameter-focal length ratios of each of the plurality of back lenses are the same.

The diameter-focal length ratios of each of the plurality of front lenses are equal to the diameter-focal length ratios of each of the plurality of back lenses.

A number of the plurality of SLM regions, a number of the plurality of front lenses, a number of the plurality of filters, and a number of the back lenses are all the same.

Heights of each of the plurality of SLM regions are the same.

A first front lens of the plurality of front lenses refracts a first beam transmitted from a first SLM region of the plurality of SLM regions, a first filter of the plurality of filters filters the first beam refracted by the first front lens, and a first back lens of the plurality of back lenses refracts the filtered first beam to form an interference image.

Each of the first front lenses includes a planar front lens plane, each of the first back lenses includes a planar back lens surface, and the front lens surface and the back lens surface are in contact with each other.

The front lens surface and the back lens surface are in contact with the first filter therebetween.

A thickness of the first front lens is twice the focal length of the first front lens, and a thickness of the first back lens is twice the focal length of the first back lens.

The spatial light modulator displays the hologram, and each of the plurality of SLM regions rotates a plurality of partial areas of the hologram, and displays the plurality of rotated partial areas of the hologram.

An apparatus for displaying a hologram according to an exemplary embodiment of the present invention includes: a beam source configured to output a coherent beam; a spatial light modulator configured to include a first SLM (spatial light modulator) region, display a hologram, and diffract the output beam; a plurality of front lenses configured to include a first front lens corresponding to the first SLM region and refracting the beam diffracted from the first SLM region; a plurality of filters configured to include a first filter corresponding to the first SLM region and filtering a part of the refracted beam; and a plurality of back lenses configured to include a first back lens corresponding to the first SLM region and displaying a first partial image of an interference image corresponding to the hologram using the filtered partial beam.

A diameter-focal length ratio of the first front lens is equal to a diameter-focal length ratio of the first back lens.

A height of the first SLM region, a height of the first front lens, a height of the first filter, and a height of the first back lens are all the same.

The first front lens includes a planar front lens surface, the first back lens includes a planar back lens surface, and the front lens surface and the back lens surface are in contact with each other.

The front lens surface and the back lens surface are in contact with the first filter therebetween.

A thickness of the first front lens is twice the focal length of the first front lens, and a thickness of the first back lens is twice the focal length of the first back lens.

The spatial light modulator displays the hologram, and the first SLM region rotates a first partial area of the hologram and displays the rotated first partial area.

An apparatus for displaying a hologram according to an exemplary embodiment of the present invention includes: a beam source configured to output a beam; a spatial light modulator configured to include a first SLM (spatial light modulator) region, display a hologram, and diffract the output beam; a plurality of front lenses configured to include a first front lens having a height that is equal to a height of the first SLM region and refracting the beam diffracted from the first SLM region; a plurality of filters configured to include a first filter having a height that is equal to a height of the first SLM region and filtering a part of the refracted beam; and a plurality of back lenses configured to include a first back lens having a height that is equal to a height of the first SLM region displaying a first partial image of an interference image corresponding to the hologram using the filtered part beam.

A diameter-focal length ratio of the first front lens is equal to a diameter-focal length ratio of the first back lens.

### BRIEF DESCRIPTION OF THE DRAWINGS

FIG. 1 shows a hologram displaying apparatus according to the conventional art.

FIG. 2 shows a hologram displaying apparatus according to an exemplary embodiment of the present invention.

FIG. 3 shows the hologram displaying apparatus according to an exemplary embodiment of the present invention.

FIG. 4 shows a plurality of regions of the spatial light modulator according to an exemplary embodiment of the present invention.

FIG. 5 shows another example of a plurality of regions of the spatial light modulator according to an exemplary embodiment of the present invention.

FIG. 6 shows the hologram displaying apparatus according to an exemplary embodiment of the present invention.

FIG. 7 shows the lens according to an exemplary embodiment of the present invention.

FIG. 8 shows a plurality of front lenses and back lenses according to an exemplary embodiment of the present invention.

FIG. 9 shows an input hologram image and an output hologram image according to the conventional art.

FIG. 10 shows the hologram displaying apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

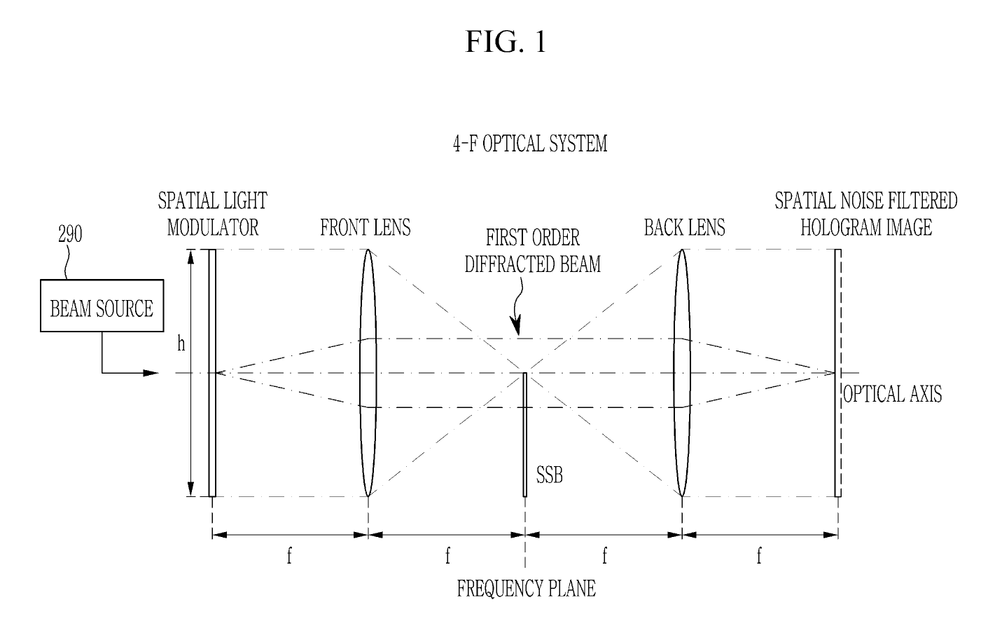

FIG. 1 shows the hologram displaying apparatus according to the conventional art.

According to the conventional art, the spatial light modulator used in the display technique of the digital hologram has a periodic pixel structure, and is composed of a digital device such as a liquid crystal (LC) device or a digital micro-mirror device (DMD).

The hologram contains diffraction information calculated for a particular purpose. After displaying the hologram on the spatial light modulator, if the interference beam is irradiated on the spatial light modulator, the amplitude information and phase information of the beam recorded on the hologram is displayed by diffracting the beam.

The above method can be expressed by a simple formula. The hologram with diffraction information can be expressed as an interference image between the object beam (UO) and the reference beam (UR), using Equation 1 below.

|U_{O}+U_{R}|²=U_{O}U_{R}*+|U_{R}|²+|U_{O}|²+U_{O}*U_{R} [Equation 1]

By irradiating the coherent beam, which is a reference beam, to the displayed hologram, the beam UH expressed as Equation 2 below is displayed.

U_{H}=U_{O}|U_{R}|²+|U_{R}|²U_{R}+|U_{O}|²U_{R}+U_{O}*U_{R}² [Equation 2]

In Equation 2 above, the first term of the right side is the beam whose object beam is displayed, the second and third terms are DC beams that are proportional to the reference beam, and the fourth term is a conjugate term having an opposite phase to that of the object beam.

In Equation 2 above, the DC beams and the conjugate beam, which are the second to fourth terms, except for the first term which is the object beam to be displayed, are defined as unintended noise information at the time of display. Generally, noise information is information that should be removed before applying digital holography.

In addition to the DC component and the conjugate components described above, a plurality of higher order diffraction terms generated by the periodic pixel structure of the spatial light modulator acting as diffraction lattices can also be defined as noise information of the digital holography. In general, the diffraction terms of the first order component of the plurality of diffraction terms except the higher order terms are selectively filtered, and used as hologram display information.

According to the conventional art, in order to remove the noise components such as the DC components, the conjugate component, and the high-order component in the digital hologram displaying apparatus, a spatial filtering technique such as single-sideband (SSB) spatial filtering shown in FIG. 1 is mainly used.

The SSB spatial filter includes a 4-f optical system. In FIG. 1, the focal lengths of lens 1 and lens 2 are shown to be the same, but the present invention is not limited thereto. The 4-f optical system images spatial information of the surface located before the focal length of the lens 1 from the lens 1 to the surface located behind the focal length of the lens 2 from the lens 2. In addition, the spatial information of the surface located before the focal length of the lens 1 from the lens 1 is transmitted as frequency information and is transmitted to a surface located behind the focal length of the lens 2 from the lens 2.

The noise information generated in the digital hologram displaying apparatus is distributed in each of specific spaces in the frequency plane of the 4-f optical system. The DC component passes through an optical axis point in the frequency plane, and the high-order components pass through the frequency point in the frequency plane defined by the diffraction angle.

The conjugate component is adjusted to pass through a specific location on the frequency plane through hologram image processing. The SSB spatial filtering apparatus determines the single half bandwidth (a lower part of the beam axis on the frequency plane in FIG. 1) region that maximally includes the first order diffracted component among the n-th order diffracted components as a position in the frequency plane for the conjugate component pass through.

In the above case, it is possible to remove the noise information by locating a spatial filter including an opposite single-sideband bandwidth of the frequency plane where a conjugate component of the first order diffracted component does not pass through as an aperture, on the frequency plane.

As a result, an image of a valid hologram where noise components such as DC components, a conjugate component, and a high-order component have been removed is formed on a surface behind the focal length of the lens 2 from the lens 2.

The conventional art SSB spatial filtering apparatus includes an SSB filter including a 4-f optical system including a lens having a larger diameter than the effective region of the spatial light modulator used in the digital hologram displaying apparatus. In order to construct such an SSB filter, a beam path corresponding to twice the sum of the focal lengths of the two lenses constituting the 4-f optical system (for example, lens 1 and lens 2) is required. Conditions for the optical path are constrained to down-size the digital hologram displaying apparatus.

In order to reduce the optical path of the digital hologram displaying apparatus, SSB spatial filters should be constructed using lenses with short focal lengths with a diameter larger than that of the spatial light modulator. That is, to minimize the optical path, a lens with a minimum F/# (focal length/diameter) value should be used for the 4-f optical system.

The lens constituting the 4-f optical system of the SSB filter having the same diameter h as the spatial light modulator shown in FIG. 1 has the F/# value equal to the f/h (f is the focal length of the lens and h is the height of the lens) value. In general, the focal length of a lens is inversely proportional to the curvature of the lens surface, so the minimum value of the curvature of the lens is limited to half the diameter with the diameter of the lens fixed.

Therefore, when a spatial filter is fabricated, there is a restriction that the physically producible lens must be larger than the minimum value of F/#. Also, as the F/# value gets smaller, the degree of distortion occurring in the lens increases, and it is difficult to use it in a digital hologram displaying apparatus.

As a result, there is a limitation in reducing the optical path of the spatial filtering apparatus using SSB of the conventional art, according to the described constraints.

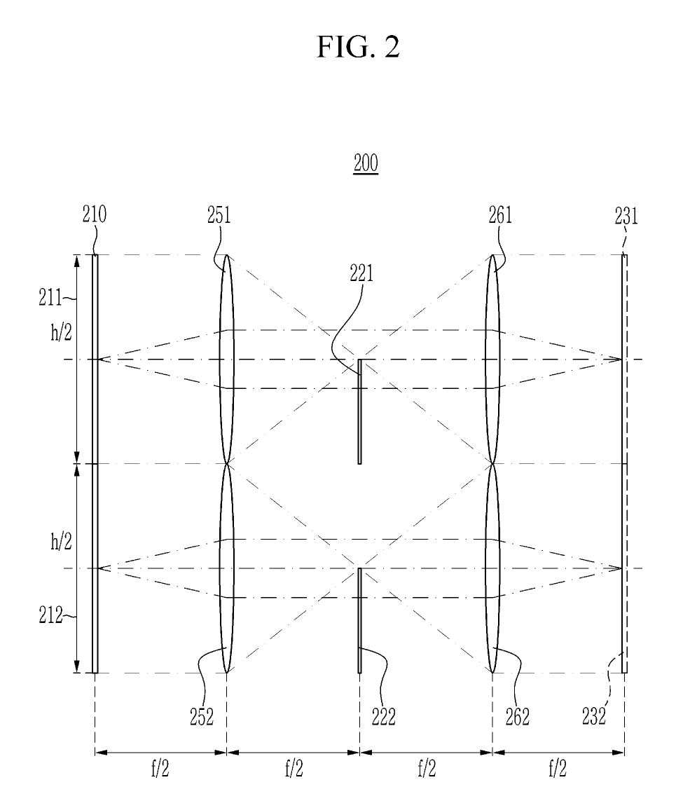

Hereinafter, referring to FIG. 2 to FIG. 8, a spatial filtering apparatus according to an exemplary embodiment of the present invention, which can reduce the size of a hologram displaying apparatus by reducing the optical path, is described.

FIG. 2 shows the hologram displaying apparatus according to an exemplary embodiment of the present invention.

As shown in FIG. 2, a hologram displaying apparatus 200 includes a spatial light modulator 210, a plurality of filters 221 and 222, a plurality of front lenses 251 and 252, and a plurality of back lenses 261 and 262.

In the following description with reference to FIG. 2, it is assumed that the region of the spatial light modulator 210 is divided into four regions of 2×2. However, as FIG. 2 shows a planar form of the hologram displaying apparatus for convenience, only two regions among the four regions are shown. The following description for the two regions of the spatial light modulator can be applied to both of the remaining two regions, which is obvious to a person of ordinary skill in the art.

In the following description with reference to FIG. 2, it is assumed that all lenses have the same lens characteristic value (F/#, focal length divided by diameter) of a specific lens having a diameter h and a focal length f. That is, if the diameter of the lens shown in FIG. 2 is h/2, the focal length is f/2.

According to an exemplary embodiment of the present invention, the spatial light modulator 210 includes a plurality of SLM (spatial light modulator) regions 211 and 212. When the spatial light modulator 210 is equally divided into four regions of 2×2, if the height of the spatial light modulator 210 is h, the height of each SLM region is h/2. That is, the spatial light modulator 210 can be divided into four SLM regions having the same height.

A plurality of SLM regions 211 and 212 display one hologram image together. That is, if the spatial light modulator 210 is divided with two regions of an upper region and a lower region as shown in FIG. 2, the upper SLM region 211 displays an upper part area of the hologram image, and the lower SLM region 212 displays a lower part area of the hologram image.

The beam source 290 outputs the coherent beam to the spatial light modulator 210. The coherent beam passing through the spatial light modulator 210 is diffracted and transmitted to a plurality of front lenses 251 and 252 at positions f/2 away from the spatial light modulator 210. That is, the upper beam having passed through the upper SLM region 211 is transmitted to the upper front lens 251 among the plurality of front lenses 251 and 252, and the lower beam having passed through the lower SLM region 212 is transmitted through the lower front lens 252.

The plurality of front lenses 251 and 252 refract (or collimate) the transmitted upper beam and lower beam into parallel waves of parallel beams. The upper front lens 251 among the plurality of front lenses 251 and 252 refracts the upper beam having passed through the upper SLM region 211 to an upper parallel wave, and the lower front lens 252 refracts the lower beam having passed through the lower SLM region 212 to a lower parallel wave.

The plurality of front lenses 251 and 252 transmit parallel waves to a plurality of back lenses 261 and 262, respectively. The plurality of parallel waves refracted by the plurality of front lenses 251 and 252 are transmitted to a plurality of back lenses 261 and 262, respectively, and a plurality of filters 221 and 222 separated by f/2 from the plurality of front lenses 251 and 252 filter part of the parallel waves (or beams) and block remaining parallel waves (or beams).

For example, the upper filter 221 among the plurality of filters 221 and 222 blocks the diffracted component including a DC component and more than second order diffracted components of the upper parallel wave refracted by the upper front lens 251, and pass through the first order diffracted component of the upper parallel waves. The lower filter 222 among the plurality of filters 221 and 222 blocks the diffracted component including a DC component and the more than second order diffracted components of the lower parallel wave refracted by the lower front lens 252, and pass through first order diffracted component of the lower parallel wave.

The first order diffracted components of the parallel waves filtered by the plurality of filters 221 and 222 are transmitted to the plurality of back lenses 261 and 262 separated by f/2 from the plurality of filters 221 and 222, respectively. The plurality of back lenses 261 and 262 refract the first order diffracted component of the transmitted parallel wave.

In other words, an upper back lens 261 of the plurality of back lenses 261 and 262 refracts the first order diffracted component of the upper parallel wave filtered by the upper filter 221. Also, the lower back lens 262 of the plurality of back lenses 261 and 262 refracts the first order diffracted component of the lower parallel wave filtered by the lower filter 222.

The first order diffracted components of the parallel waves refracted by the plurality of back lenses 261 and 262 are interfered with in the hologram plane 231 and 232 to form an interference image. That is, the first order diffracted component of the upper parallel wave refracted by the upper back lens 261 forms an upper interference image at the upper hologram region 231 of the hologram plane 231 and 232. Also, the first order diffracted component of the lower parallel wave refracted by the lower back lens 262 forms a lower interference image in the lower hologram region 232 of the hologram plane 231 and 232.

The upper interference image and the lower interference images form an entire interference image.

Corresponding to the number of the spatial light modulator regions, the hologram displaying apparatus 200 includes four front lens and four back lenses of 2×2 of diameter h/2. The focal length of each of the four (2×2) front lenses and four back lenses with a diameter of h/2 is half of the focal length of a lens with a diameter of h, and is f/2. As a result, when using four front lenses and four back lenses, the beam path is reduced by half compared to using lenses having focal length f.

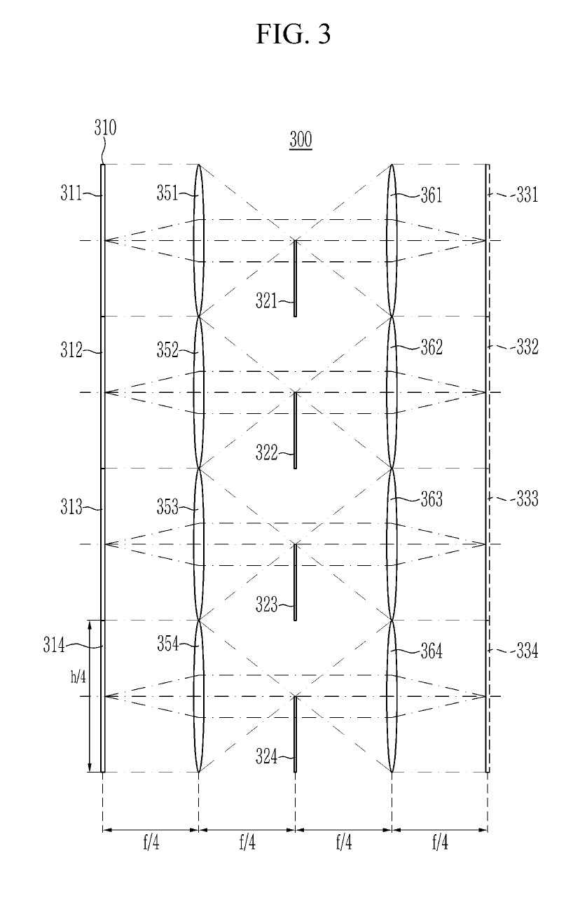

FIG. 3 shows the hologram displaying apparatus according to an exemplary embodiment of the present invention.

As shown in FIG. 3, the hologram displaying apparatus 300 includes a spatial light modulator 310, a plurality of filters 321, 322, 323, and 324, a plurality of front lenses 351, 352, 353, 354, and a plurality of back lenses 361, 362, 363, and 364.

In the following description with reference to FIG. 3, it is assumed that the region of the spatial light modulator 210 is divided into 16 regions of 4×4. However, as FIG. 3 shows a planar form of the hologram displaying apparatus for convenience, only four regions among the 16 regions are shown. The following description for the four regions of the spatial light modulator can be applied to all of the remaining twelve regions, which is obvious to a person of ordinary skill in the art.

In the following description with reference to FIG. 3, it is assumed that all lenses have the same lens characteristic value (F/#, focal length divided by diameter) of a specific lens having a diameter h and a focal length f. That is, when diameter of a lens shown in FIG. 3 is h/4, the focal length is f/4.

According to an exemplary embodiment of the present invention, the spatial light modulator 310 includes a plurality of SLM regions 311, 312, 313, and 314. When the spatial light modulator 310 is equally divided into 16 regions of 4×4, if the height of the spatial light modulator 310 is h, the height of each SLM region is h/4. That is, the spatial light modulator 310 can be divided into 16 SLM regions having the same height.

The plurality of SLM regions 311, 312, 313, and 314 display one hologram image together. That is, if the spatial light modulator 310 is divided with four regions of first, second, third, and fourth regions as shown in FIG. 3, a first SLM region 311 of the plurality of SLM regions 311, 312, 313, and 314 displays a first partial area of the hologram image, a second SLM region 312 displays a second partial area of the hologram image, a third SLM region 313 displays a third partial area of the hologram image, and a fourth SLM region 314 displays a fourth partial area of the hologram image.

The beam source 290 outputs a coherent beam to the spatial light modulator 310. The coherent beam passing through spatial light modulator 310 is diffracted and transmitted to a plurality of front lenses 351, 352, 353, and 354. That is, the first beam passing through the first SLM region 311 is transmitted to the first front lens 351 among the plurality of front lenses 351, 352, 353, and 354, the second beam passing through the second SLM region 312 is transmitted to the second front lens 352 among the plurality of front lenses 351, 352, 353, and 354, the third beam passing through the third SLM region 313 is transmitted to the third front lens 353 among the plurality of front lenses 351, 352, 353, and 354, and the fourth beam passing through the fourth SLM region 314 is transmitted to the fourth front lens 354 among a plurality of front lenses 351, 352, 353, and 354.

The plurality of front lenses (351, 352, 353, and 354) refract the transmitted beam into parallel waves of parallel beams. The first front lens 351 of the plurality of front lenses 351, 352, 353, and 354 refracts the first beam passing through the first SLM region 311 to a first parallel wave, the second front lens 352 refracts the second beam passing through the second SLM region 312 to a second wave, the third front lens 353 refracts the third beam passing through the third SLM region 313 to a third parallel wave, and the fourth front lens 354 refracts the fourth beam passing through the fourth SLM region 314 to a fourth parallel wave.

The plurality of front lenses 351, 352, 353, and 354 transmit the parallel waves to the plurality of back lenses 361, 362, 363, and 364. The plurality of parallel waves refracted by the plurality of front lenses 351, 352, 353, and 354 are transmitted to the plurality of back lenses 361, 362, 363, and 364, respectively, and the plurality of filters 321, 322, 323, and 324 filter part of the parallel waves (or beams), and blocks remaining parallel waves (or beams).

For example, a first filter 321 of the plurality of filters 321, 322, 323, and 324 blocks a DC component and more than second order diffracted components of the first parallel wave refracted by the first front lens 351, and passes the first order diffracted component of the first parallel wave. The second filter 322 blocks a DC component and more than second order diffracted components of the second parallel wave refracted by the second front lens 352, and passes the first order diffracted component of the second parallel wave. The third filter 323 blocks a DC component and more than second order diffracted components of the third parallel wave refracted by the third front lens 353, and passes the first order diffracted component of the third parallel wave. The fourth filter 324 blocks a DC component and more than second order diffracted components of the fourth parallel wave refracted by the fourth front lens 352, and passes the first order diffracted component of the fourth parallel wave.

The first order diffracted components of the parallel waves filtered by the plurality of filters 321, 322, 323, and 324 are transmitted to the plurality of back lenses 361, 362, 363, and 364. The plurality of back lenses 361, 362, 363, and 364 refract the first order diffracted component of the transmitted parallel wave.

That is, the first back lens 361 of the plurality of back lenses 361, 362, 363, and 364 refracts the first order diffracted component of the first parallel wave filtered by the first filter 321. Also, the second back lens 362 refracts the first order diffracted component of the second parallel wave filtered by the second filter 322. Further, the third back lens 363 refracts the first order diffracted component of the third parallel wave filtered by the third filter 323. Also, the fourth back lens 364 refracts the first order diffracted component of the fourth parallel wave filtered by the fourth filter 324.

The first order diffracted components of the parallel waves refracted by the plurality of back lenses 361, 362, 363, and 364 are interfered with and form an interference image at a plurality of hologram regions 331, 332, 333, and 334 of the hologram plane. That is, a first order diffracted component of the first parallel wave refracted by the first back lens 361 forms a first interference image at the first hologram region 331 of the plurality of hologram regions (331, 332, 333, and 334) of the hologram plane. Also, a first order diffracted component of the second parallel wave refracted by the second back lens 362 forms a second interference image in the second hologram region 332 of the hologram plane. Further, a first order diffracted component of the third parallel wave refracted by the third back lens 363 forms a third interference image in the third hologram region 333 of the hologram plane. Also, a first order diffracted component of the fourth parallel wave refracted by the fourth back lens 364 forms a fourth interference image in the fourth hologram region 334 of the hologram plane.

The first interference image, the second interference image, the third interference image, and the fourth interference image form the entire interference image.

Corresponding to the number of the spatial light modulator regions, the hologram displaying apparatus 200 includes 16 front lenses and 16 back lenses of 4×4, each having a diameter of h/4. Each focal length of 16 front lenses and 16 back lenses each having a diameter of h/4 are ¼ of f, which is a focal length of a lens with a diameter of h, and is f/4.

As a result, when using 16 front lenses and 16 back lenses compared to using a lens of a focal length f, the beam path is reduced to ¼.

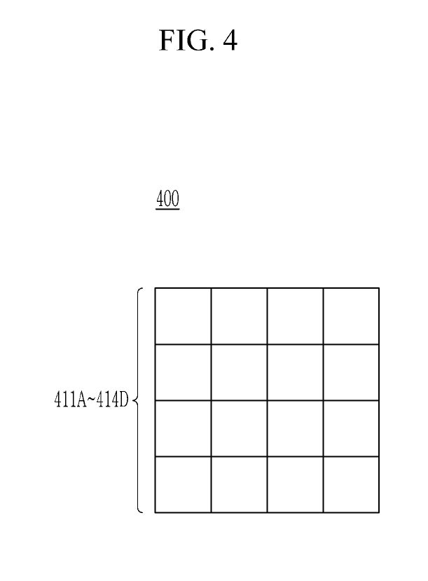

FIG. 4 shows a plurality of regions of the spatial light modulator according to an exemplary embodiment of the present invention.

With a same principle as described referring to FIG. 2 to FIG. 3, by increasing the number of divided regions of the spatial light modulator 210 or 310, the number of the plurality of filters can be increased correspondingly. That is, the optical path of the hologram displaying apparatus is reduced in proportion to the number of division regions of the spatial light modulator.

According to an exemplary embodiment of the present invention, a condition is defined that there is no redundant or empty space between each divided region of the spatial light modulator. For a plurality of divided regions of the spatial light modulator having a two-dimensional planar structure, examples of geometrical shapes according to the above conditions include triangular, tetragonal, and hexagonal.

As an example of a filter according to the present invention as shown in FIG. 4, a spatial light modulator 410 can be divided into a plurality of quadrangular SLM regions (411A-414D).

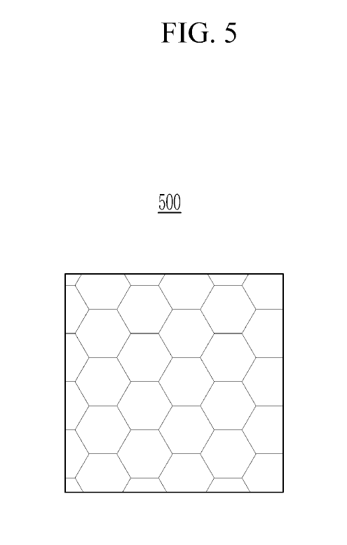

FIG. 5 shows another example of a plurality of regions of a spatial light modulator according to an exemplary embodiment of the present invention.

As another example of a filter according to the present invention as shown in FIG. 5, the spatial light modulator 510 can be divided into a plurality of hexagonal SLM regions.

FIG. 4 and FIG. 5 illustrate the division of a spatial light modulator using a geometric shape having periodic intervals, but it may be divided into regions having different shapes under a condition that does not allow redundancy and gaps. In addition, as long as there is no manufacturing problem with respect to the shape of a plurality of lenses of each of the hologram displaying apparatus, the region can be divided into shapes other than geometric shapes.

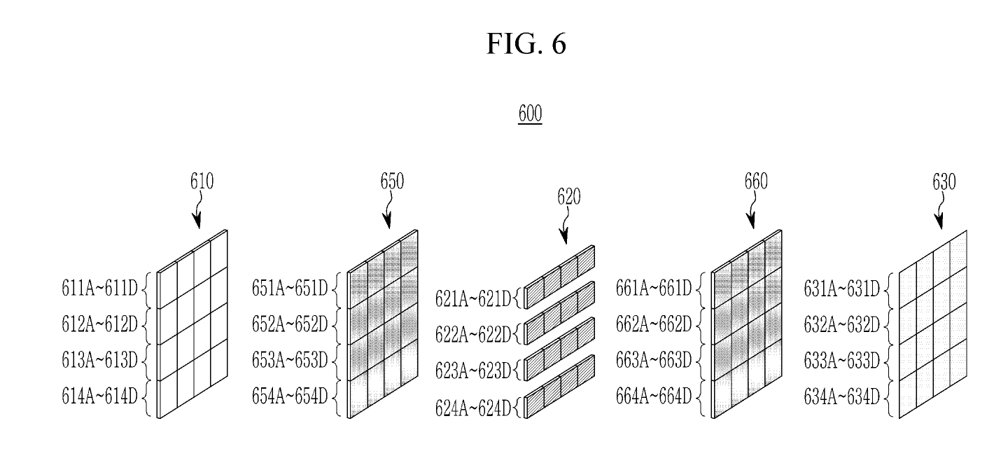

FIG. 6 shows the hologram displaying apparatus according to an exemplary embodiment of the present invention.

As shown in FIG. 6, the hologram displaying apparatus 600 displays a plurality of interference images on the hologram plane 630 using a spatial light modulator 610, a plurality of filters 620, a plurality of front lenses 650, and a plurality of back lenses 660.

The spatial light modulator 610 is divided into a plurality of SLM regions 611A-611D, 612A-612D, 613A-613D, and 614A-614D composed of periodic patterns. The first SLM lines 611A-611D each display a part of the hologram image. The first SLM lines 611A-611D respectively diffract a plurality of first line beams output from the beam source 290. It is obvious to a person of ordinary skill in the art that the description for the first SLM lines 611A-611D can be applied to functions of the second SLM lines 612A-612D, the third SLM lines 613A-613D, and the fourth SLM lines 614A-614D.

First lines 651A-651D of the plurality of front lenses 650 refract a first line beam diffracted from the first SLM line 611A-611D of the spatial light modulator 610 to a first line parallel wave. The description for the first lines 651A-651D of the front lens can be applied to the second lines 652A-652D, the third lines 653A-653D, and the fourth lines 654A-654D of the front lens.

First line filters 621A-621D of the plurality of filters 620 block a DC component and more than second order diffracted components of the first line parallel wave refracted from the first lines 651A-651D of the front lens, and filter a first order diffracted component of a first line parallel wave. The description for the first line filters 621A-621D can also be applied to the second line filters 622A-622D, the third line filters 623A-623D, and the fourth line filters 624A-624D.

First lines 661A-661D of the plurality of back lenses 660 refract the first order diffracted component of the first line parallel wave filtered through the first filter lines 621A-621D, and form first line interference images 631A-631D on the hologram plane 630. The description for the first lines 661A-661D of the back lenses and the first line interference images 631A-631D also applies to the second lines 662A-662D, the third lines 663A-663D and the fourth lines 664A-664D of the back lenses and the second line interference images 632A-632D, the third line interference images 633A-633D, and the fourth line interference images 634A-634D.

Although the filter shown in FIG. 2, FIG. 3, and FIG. 6 is formed to include an aperture in a region corresponding to a single half of each region of the spatial light modulator, the filter is not necessarily limited to this, and it can be set to the left or to the right of the filter.

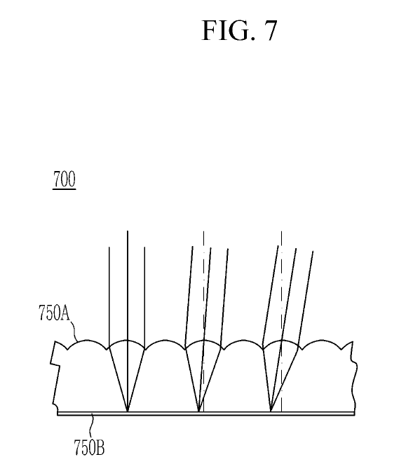

FIG. 7 shows the lens according to an exemplary embodiment of the present invention.

When configuring a hologram displaying apparatus according to an exemplary embodiment of the present invention, there are some problems in determining an exact location between the spatial light modulator, the plurality of front lenses, the plurality of filters, and the plurality of back lenses and aligning them together.

In order to solve the above problem, as shown in FIG. 7, according to an exemplary embodiment of the present invention, a first surface 750A of the lens 700 is configured in a spherical shape, and a second surface 750B of the lens 700 is configured in a planar shape. That is, the lens 700 may be convex-plano.

In other words, the beam diffracted by the spatial light modulator (e.g., the spatial light modulator 610 of FIG. 6) is incident on the spherical-shaped incidence surface 750A among the plurality of surfaces of each of the plurality of front lenses, and is output through the planar-shaped emitting surface 750B.

In addition, the beam emitted through the emitting surface 750B of the plurality of surfaces of each of the plurality of front lenses is incident on a plane-shaped incident surface among the plurality of surfaces of each of the plurality of back lenses, and is emitted to the emitting surface of a spherical shape.

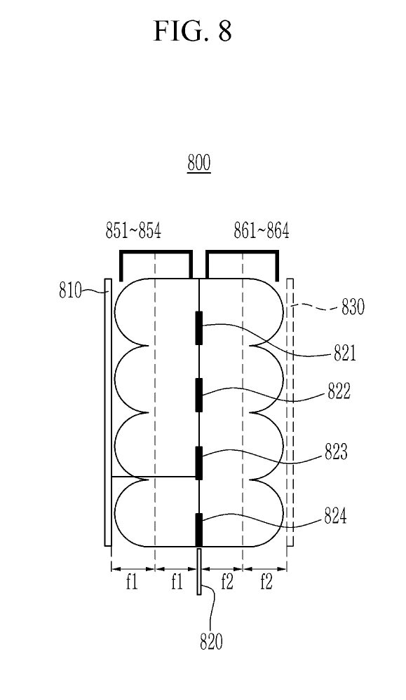

FIG. 8 shows a plurality of front lenses and back lenses according to an exemplary embodiment of the present invention.

As described in FIG. 7, each of a plurality of front lenses 851-854 and a plurality of back lenses 861-864 includes a spherical surface and a planar surface.

By adjusting the curvature and the constituent material of the lens, as shown in FIG. 8, a focal plane of the plurality of front lenses can be positioned on a plane of the emitting plane of the plurality of front lenses. Also, as shown in FIG. 8, a thickness (or a length from left to right) of each of the plurality of front lenses 851-854 can be twice the focal length f1 of the plurality of front lenses. Also, a thickness (or a length from left to right) of each of the plurality of back lenses 861-864 can be twice the focal length f2 of each of the plurality of back lenses.

As shown in FIG. 8, a planar-shaped emitting surface of the plurality of front lenses 851-854 is in contact with the spherical incident surface of each of the plurality of back lenses 861-864. Accordingly, it is possible to align the positions of the plurality of front lenses 851-854 and the plurality of back lenses 861-864. When the filter is constructed as above, a plane where the emitting plane of the plurality of front lenses 851-854 and the incident surface of the plurality of back lenses 861-864 are in contact can be the frequency plane of the hologram displaying apparatus, and the focal plane of the plurality of front lenses 851-854 and the plurality of back lenses 861-864, simultaneously.

The spatial light modulator 810 is also aligned with the plurality of front lenses 851-854, the plurality of back lenses 861-864, and the plurality of filters 821, 822, 823, and 824.

Also, the plurality of filters 821, 822, 823, and 824 are inserted between the plurality of front lenses 851-854 and the plurality of back lenses 861-864 on the lens plane 820. In other words, the first front lens 851 of the plurality of front lenses and a first back lens 861 of the plurality of back lenses are in contact with each other, and the first filter is disposed between the first front lens 851 and the first back lens 861.

According to the description above, the first beam which is a part of the beam output from the beam source 290 is diffracted through the spatial light modulator 810 of the hologram displaying apparatus 800. The diffracted first beam is incident on the spherical incident surface of first front lens 851. The incident first beam is emitted to the plane-shaped emitting surface of the first front lens 851. The first order diffracted component of the first beam is filtered by the first filter 821 which is in contact with the emitting surface of the first front lens 851. The first order diffracted component of the filtered first beam is incident on the plane-shaped incident surface of the first back lens 861 which is in contact with both the first front lens 851 and the first filter 821. The first order diffracted component of the incident first beam is emitted through the spherical emitting surface of the first back lens 861, and forms an interference image on the hologram plane 830.

The description above can be applied to the second beam, the third beam, and the fourth beam, and to the second front lens 851, the third front lens 853, and the fourth front lens 854, as well as the second back lens 862, the third back lens 863, and the fourth back lens 864, which is a remaining part of the output beam.

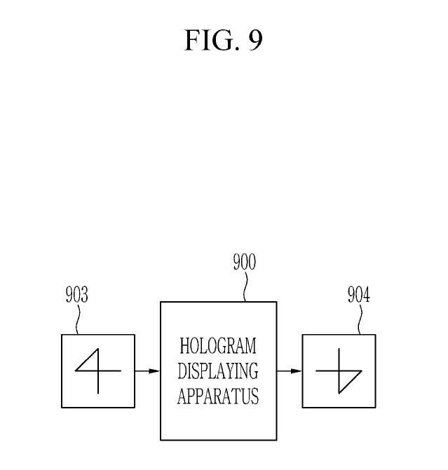

FIG. 9 shows the input hologram image and output hologram image according to the conventional art.

As shown in FIG. 9, according to the conventional art, when the hologram displaying apparatus 900 displays the output hologram image 904, if there is no separate preprocessing, the output hologram image 904 is transformed into the left/right/upper/lower inverted form (or a 180 degree rotated form) of the input hologram image 903.

According to an exemplary embodiment of the present invention, the output interference image is not transmitted through a single optical path, but a plurality of partial areas of the interference image are formed through a plurality of optical paths, and since the entire output hologram image is formed by each of the plurality of partial areas of the interference image, it is necessary to preprocess for each partial area of the interference images.

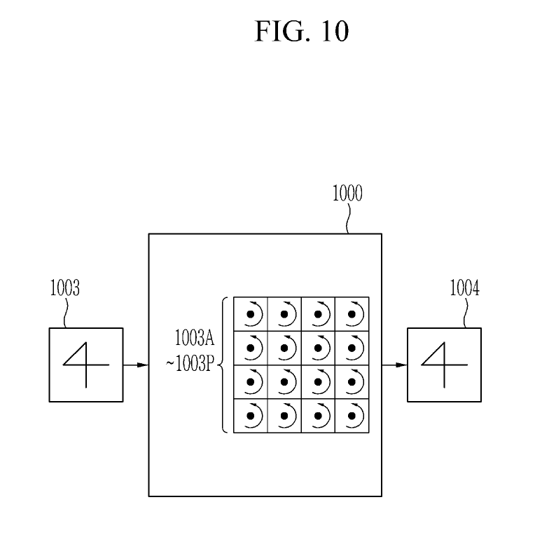

FIG. 10 shows the hologram displaying apparatus according to an exemplary embodiment of the present invention.

As shown in FIG. 10, in order to solve the problem described referring to FIG. 9, the hologram displaying apparatus 1000 loads the input image 1003, and divides and displays the input image 1003 into a plurality of SLM regions of the spatial light modulator.

Before displaying the input image 1003 on the plurality of SLM regions of the spatial light modulator, the hologram displaying apparatus 1000 rotates the partial areas of the input image 1003A-1003P loaded on each of the SLM regions in directions of left/right/upper/lower (or rotated by 180 degrees), as shown in FIG. 10.

After rotating the plurality of partial areas of the input image 1003A-1003P loaded on each SLM region, the hologram displaying apparatus 1000 outputs an output image 1004 having a same phase as the input image 1003 using the plurality of rotated images.

According to an exemplary embodiment of the present invention, optical paths of the hologram displaying apparatus can be drastically reduced, thereby reducing the overall size of the hologram displaying apparatus, thereby down-sizing the digital hologram display system.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for displaying a hologram, comprising:
a beam source configured to output a plurality of beams;
a spatial light modulator configured to include a plurality of SLM (spatial light modulator) regions, display a hologram, and diffract the plurality of beams;
a plurality of front lenses each corresponding to the plurality of SLM regions, and configured to refract the plurality of beams diffracted from each of the plurality of SLM regions;
a plurality of filters each corresponding to the plurality of SLM regions, and configured to filter a part of the plurality of refracted beams; and
a plurality of back lenses each corresponding to the plurality of SLM regions, and configured to display an interference image corresponding to the hologram using the filtered part beam.

2. The apparatus of claim 1,
wherein diameter-focal length ratios of each of the plurality of front lenses are the same.

3. The apparatus of claim 2,
wherein diameter-focal length ratios of each of the plurality of back lenses are the same.

4. The apparatus of claim 3,
wherein the diameter-focal length ratios of each of the plurality of front lenses are equal to the diameter-focal length ratios of each of the plurality of back lenses.

5. The apparatus of claim 1,
wherein a number of the plurality of SLM regions, a number of the plurality of front lenses, a number of the plurality of filters, and a number of the back lenses are the same.

6. The apparatus of claim 5,
wherein heights of each of the plurality of SLM regions are the same.

7. The apparatus of claim 1, wherein:
a first front lens of the plurality of front lenses refracts a first beam transmitted from a first SLM region of the plurality of SLM regions;
a first filter of the plurality of filters filters the first beam refracted by the first front lens; and
a first back lens of the plurality of back lenses refracts the filtered first beam to form an interference image.

8. The apparatus of claim 7, wherein:
each of the first front lenses includes a planar front lens plane;
each of the first back lenses includes a planar back lens surface; and
the front lens surface and the back lens surface are in contact with each other.

9. The apparatus of claim 8, wherein
the front lens surface and the back lens surface are in contact with the first filter therebetween.

10. The apparatus of claim 9, wherein
a thickness of the first front lens is twice the focal length of the first front lens, and
a thickness of the first back lens is twice the focal length of the first back lens.

11. The apparatus of claim 1, wherein
the spatial light modulator displays the hologram, and
each of the plurality of SLM regions rotates a plurality of partial areas of the hologram, and displays the plurality of rotated partial areas of the hologram.

12. An apparatus for displaying a hologram, comprising:
a beam source configured to output a coherent beam;
a spatial light modulator configured to include a first SLM (spatial light modulator) region, display a hologram, and diffract the output beam;
a plurality of front lenses configured to include a first front lens corresponding to the first SLM region and refracting the beam diffracted from the first SLM region;
a plurality of filters configured to include a first filter corresponding to the first SLM region and filtering a part of the refracted beam; and
a plurality of back lenses configured to include a first back lens corresponding to the first SLM region and displaying a first partial image of an interference image corresponding to the hologram using the filtered partial beam.

13. The apparatus of claim 12, wherein
a diameter-focal length ratio of the first front lens is equal to a diameter-focal length ratio of the first back lens.

14. The apparatus of claim 12, wherein
a height of the first SLM region, a height of the first front lens, a height of the first filter, and a height of the first back lens are the same.

15. The apparatus of claim 12, wherein:
the first front lens includes a planar front lens surface;
the first back lens includes a planar back lens surface; and
the front lens surface and the back lens surface are in contact with each other.

16. The apparatus of claim 15, wherein
the front lens surface and the back lens surface are in contact with the first filter therebetween.

17. The apparatus of claim 16, wherein
a thickness of the first front lens is twice the focal length of the first front lens, and
a thickness of the first back lens is twice the focal length of the first back lens.

18. The apparatus of claim 12, wherein
the spatial light modulator displays the hologram, and
the first SLM region rotates a first partial area of the hologram and displays the rotated first partial area.

19. An apparatus for displaying hologram, comprising:
a beam source configured to output a beam;
a spatial light modulator configured to include a first SLM (spatial light modulator) region, display a hologram, and diffract the output beam;
a plurality of front lenses configured to include a first front lens having a height that is equal to a height of the first SLM region and refracting the beam diffracted from the first SLM region;
a plurality of filters configured to include a first filter having a height that is equal to a height of the first SLM region and filtering a part of the refracted beam; and
a plurality of back lenses configured to include a first back lens having a height that is equal to height of the first SLM region displaying a first partial image of an interference image corresponding to the hologram using the filtered part beam.

20. The apparatus of claim 19, wherein
a diameter-focal length ratio of the first front lens is equal to a diameter-focal length ratio of the first back lens.
